(19) United States
(12) Patent Application Publication
(10) Pub. No.: US 2018/0285855 A1
(43) Pub. Date: Oct. 4, 2018

(54) SYSTEM FOR PROXY PAYMENT BASED ON SHARED ELECTRONIC COMMERCE SHOPPING CART, METHOD THEREOF AND NON-TRANSITORY COMPUTER READABLE STORAGE MEDIUM HAVING COMPUTER PROGRAM RECORDED THEREON

(71) Applicant: SK Planet Co., Ltd., Seongnam-si (KR)

(72) Inventor: JuTae Kim, Seongnam-si (KR)

(21) Appl. No.: 15/943,574

(22) Filed: Apr. 2, 2018

(30) Foreign Application Priority Data
Apr. 3, 2017 (KR) 10-2017-0042918

(51) Int. Cl. G06Q 20/32; G06Q 30/06

(52) U.S. Cl. CPC G06Q 20/325; G06Q 30/0641; G06Q 20/3223

(57) ABSTRACT

Disclosed are a system for proxy payment based on a shared electronic commerce shopping cart, a method thereof and a non-transitory computer readable storage medium having computer program recorded thereon. That is, according to the present invention, the payment terminal performs the proxy payment function for one or more products selected by the proxy payment request terminal, thereby enabling proxy payment (alternatively, proxy purchase) without sharing the authentication information associated with the payment terminal with the purchase request terminal, protecting personal information of the payer because the authentication information is not shared, and providing a delivery state inquiry function to both the payment terminal and the purchase request terminal.

### CROSS-REFERENCE TO RELATED APPLICATIONS

This application is based on and claims the benefit of priority to Korean Patent Application No. 10-2017-0042918 filed on Apr. 3, 2017, with the Korean Intellectual Property Office, the disclosure of which is incorporated herein by reference.

### BACKGROUND OF THE INVENTION

### Field of the Invention

The present invention relates to a system for proxy payment based on a shared electronic commerce shopping cart, a method thereof and a non-transitory computer readable storage medium having computer program recorded thereon, and more particularly, to a system for proxy payment based on a shared electronic commerce shopping cart, a method thereof and a non-transitory computer readable storage medium having computer program recorded thereon in which a payment terminal performs a proxy payment function for one or more products selected by a proxy payment request terminal.

### Description of the Related Art

An online open market (alternatively, a shopping mall) has a shopping cart (alternatively, a cart).

When a terminal of a purchase requester intends to purchase a product, the purchase requester adds a product to be purchased to a shopping cart associated with the terminal through an authentication procedure and performs the payment.

That is, there is no method of adding a desired product of another person in the shopping cart of the terminal and purchasing the product by proxy.

If there is a proxy purchase intention, authentication information such as an ID and a password associated with the corresponding shopping mall needs to be mutually shared, and as a result, there is a security problem that the purchase requester can acquire a purchase history, personal member information, and the like in addition to the shopping cart of the payer.

In addition, when the payer changes the authentication information, the purchase requester needs to request the authentication information to the payer for a proxy purchase request again, and only the payer can inquire a delivery state for the purchase product and the like, and thus, there is a problem that the purchase requester cannot know the related information.

### SUMMARY OF THE INVENTION

The present invention has been made in effort to provide a system for proxy payment based on a shared electronic commerce shopping cart, a method thereof and a non-transitory computer readable storage medium having computer program recorded thereon in which a payment terminal performs a proxy payment function for one or more products selected by a proxy payment request terminal.

Further, the present invention has been made in effort to provide a system for proxy payment based on a shared electronic commerce shopping cart, a method thereof and a non-transitory computer readable storage medium having computer program recorded thereon in which a purchase request terminal determines a payment means, a coupon application, a mileage use, and the like according to an authority setting level set by a payment terminal.

Further, the present invention has been made in effort to provide a system for proxy payment based on a shared electronic commerce shopping cart, a method thereof and a non-transitory computer readable storage medium having computer program recorded thereon, which groups a plurality of products included in a shopping cart for each purpose according to a purpose and provides a naming function for the groups. An embodiment of the present invention provides a method for proxy payment based on a shared electronic commerce shopping cart, the method comprising: transmitting, by a proxy payment request terminal, payer information, delivery information, proxy payment request information, and identification information of the proxy payment request terminal to a server in order to request proxy payment for at least one product information stored in a shopping cart associated with the proxy payment request terminal; transmitting, by the server, a web page address including the at least one product information and the proxy payment request information to a payment terminal corresponding to the payer information according to whether the payer corresponding to the payer information is registered as a member in the server; displaying, by the payment terminal, the web page address transmitted from the server and the proxy payment request information; and performing, by the payment terminal, a payment function for at least one product associated with the at least one product information included in the shopping cart of the payment terminal by interlocking with the server and a payment server when the payment function for the at least one product information included in the shopping cart of the payment terminal is selected.

As one example associated with the present invention, the transmitting of the payer information, the delivery information, the proxy payment request information, and the identification information of the proxy payment request terminal may include a process of storing, by the proxy payment request terminal, the at least one product information for requesting proxy payment in the shopping cart associated with the proxy payment request terminal by interlocking with the server; a process of displaying by the proxy payment request terminal, a shopping cart screen including the at least one product information when a shopping cart menu displayed on one side of the current screen of the proxy payment request terminal is selected; a process of displaying, by the proxy payment request terminal, a delivery information setting screen when a delivery information setting menu displayed on one side of the shopping cart screen is selected and receiving delivery information according to a user input; a process of grouping, by the proxy payment request terminal, the at least one product information included in a current shopping cart of the proxy payment request terminal by interlocking with the server when a grouping menu displayed on the other side of the shopping cart screen is selected; a process of performing, by the proxy payment request terminal, a group name setting function for a group including the at least one grouped product information according to a user input; a process of displaying, by the proxy payment request terminal, a payer selection screen for selecting a payer to request the proxy payment for at least one product information temporarily stored in a current shopping cart item when a payer selection menu displayed on another side of the shopping cart screen is selected, and receiving payer information according to a user input; and a process of transmitting, by the proxy payment request terminal, the received payer information, the received delivery information, the set group name, the proxy payment request information, and the identification information of the proxy payment request terminal to the server.

As one example associated with the present invention, the payer information may include any one of a telephone number, an email address, social network account information, and a member nickname in a shopping mall site associated with the server.

As one example associated with the present invention, the transmitting of the web page address including the at least one product information and the proxy payment request information to the payment terminal corresponding to the payer information according to whether the payer corresponding to the payer information is registered as the member in the server may include a process of checking, by the server, whether the payer corresponding to the payer information is a member pre-registered in the server; a process of determining whether a write authority for the shopping cart item associated with the payer is set, when the payer corresponding to the payer information is the member pre-registered in the server, as the checking result; a process of checking whether a use authority for at least one of payment means, coupons, and mileages associated with the payer is set, when the write authority for the shopping cart item associated with the payer is set, as the determining result; a process of applying at least one of usable payment means, coupons, and mileages associated with the payer by interlocking with the server and the proxy payment request terminal when the use authority for at least one of the payment means, the coupons, and the mileages associated with the payer is set; a process of copying and pasting and automatically storing at least one product information included in the shopping cart item associated with the proxy payment request terminal in the shopping cart item associated with the payment terminal, in the case of either when the use authority for at least one of the payment means, the coupons, and the mileages associated with the payer is not set or when at least one of the usable payment means, coupons, and mileages associated with the payer is applied by interlocking with the proxy payment request terminal; a process of generating a web page corresponding to the shopping cart item associated with the payment terminal; and a process of providing address information about the generated web page and the proxy payment request information to the payment terminal corresponding to the received payer information.

As one example associated with the present invention, as the checking result, when the payer corresponding to the payer information is not the member pre-registered in the server, the method may include a process of generating a web page capable of checking at least one product information included in the shopping cart item associated with the proxy payment request terminal based on the received proxy payment request information; and a process of providing address information about the generated web page and the proxy payment request information to the payment terminal corresponding to the received payer information.

As one example associated with the present invention, as the determining result, when the write authority for the shopping cart item associated with the payer is not set, the method may include a process of generating a web page capable of checking at least one product information included in the shopping cart item associated with the proxy payment request terminal based on the received proxy payment request information; and a process of providing address information about the generated web page and the proxy payment request information to the payment terminal corresponding to the received payer information.

As one example associated with the present invention, the method may further include transmitting, by any one of the proxy payment request terminal and the payment terminal, delivery state check request information about the at least one product paid to the server; receiving, by any one of the proxy payment request terminal and the payment terminal, delivery state inquiry information transmitted from the server in response to the transmitted delivery state check request information; and outputting, by any one of the proxy payment request terminal and the payment terminal, the received delivery state inquiry information.

Another embodiment of the present invention provides a non-transitory computer readable storage medium which may store a computer program comprising a set of instructions, when executed, arranged to cause a terminal to implement the method for proxy payment based on the shared electronic commerce shopping cart.

Yet another embodiment of the present invention provides a system for proxy payment based on a shared electronic commerce shopping cart, the system comprising: a proxy payment request terminal configured to transmit payer information, delivery information, proxy payment request information, and identification information of the proxy payment request terminal to a server in order to request proxy payment for at least one product information stored in a shopping cart associated with the proxy payment request terminal; the server configured to transmit a web page address including the at least one product information and the proxy payment request information to a payment terminal corresponding to the payer information according to whether the payer corresponding to the payer information is registered as a member in the server; and the payment terminal configured to display the web page address transmitted from the server and the proxy payment request information, and perform a payment function for at least one product associated with the at least one product information included in the shopping cart of the payment terminal by interlocking with the server and a payment server when the payment function for the at least one product information included in the shopping cart of the payment terminal is selected.

As one example associated with the present invention, the server may check whether the payer corresponding to the payer information is a member pre-registered in the server, determine whether a write authority for a shopping cart item associated with the payer is set when the payer corresponding to the payer information is the member pre-registered in the server, check whether a use authority for at least one of payment means, coupons, and mileages associated with the payer is set when the write authority for the shopping cart item associated with the payer is set, apply at least one of usable payment means, coupons, and mileages associated with the payer by interlocking with the server and the proxy payment request terminal when the use authority for at least one of the payment means, the coupons, and the mileages associated with the payer is set, copy and paste and automatically store at least one product information included in the shopping cart item associated with the proxy payment request terminal in the shopping cart item associated with the payment terminal in the case of either when the use authority for at least one of the payment means, the coupons, and the mileages associated with the payer is not set or when at least one of the usable payment means, coupons, and mileages associated with the payer is applied by interlocking with the proxy payment request terminal, generate a web page corresponding to the shopping cart item associated with the payment terminal, and provide address information about the generated web page and the proxy payment request information to the payment terminal corresponding to the received payer information.

As one example associated with the present invention, any one of the proxy payment request terminal and the payment terminal may transmit delivery state check request information about the at least one product paid to the server, receive delivery state inquiry information transmitted from the server in response to the transmitted delivery state check request information, and output the received delivery state inquiry information.

According to the present invention, the payment terminal performs the proxy payment function for one or more products selected by the proxy payment request terminal, thereby enabling proxy payment (alternatively, proxy purchase) without sharing the authentication information associated with the payment terminal with the purchase request terminal, protecting personal information of the payer because the authentication information is not shared, and providing a delivery state inquiry function to both the payment terminal and the purchase request terminal.

Further, according to the present invention, the purchase request terminal determines the payment means, whether the coupons are applied, whether the mileages are used, and the like according to an authority setting level set by the payment terminal, thereby enabling payers who are not familiar with online payment and online purchase to easily perform the purchase.

Further, according to the present invention, it is possible to variously and conveniently manage products before purchasing, by grouping a plurality of products in the shopping cart according to a purpose and providing a naming function for each group.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram illustrating a configuration of a system for proxy payment based on a shared electronic commerce shopping cart according to an embodiment of the present invention;

FIGS. 2 and 3 are flowcharts illustrating a method for proxy payment based on a shared electronic commerce shopping cart according to an embodiment of the present invention;

FIGS. 4 to 8 are diagrams illustrating a screen of a proxy payment request terminal according to the embodiment of the present invention; and

FIGS. 9 and 10 are diagrams illustrating a screen of a payment terminal according to the embodiment of the present invention.

### DETAILED DESCRIPTION OF THE PREFERRED EMBODIMENT

Technical terms used in the present invention are used only to describe specific embodiments, and are not intended to limit the present invention. Further, unless otherwise defined, the technical terms used in the present invention should be interpreted as meanings generally appreciated by those skilled in the art and should not be interpreted as excessively comprehensive meanings or excessively reduced meanings. Further, when the technical term used in the present invention is a wrong technical term that does not accurately express the spirit of the present invention, the technical term should be understood by being substituted by a technical term which can be correctly understood by those skilled in the art. In addition, a general term used in the present invention should be interpreted as defined in a dictionary or contextually, and should not be interpreted as an excessively reduced meaning.

Further, singular expressions used in the present invention include plural expressions unless they have definitely opposite meanings in the context. In the present invention, a term such as “comprising” or “including” should not be interpreted as necessarily including all various components or various steps disclosed in the invention, and it should be interpreted that some component or some steps among them may not be included or additional components or steps may be further included.

Further, terms including an ordinary number, such as first and second, and the like are used for describing various components, but the components are not limited by the terms. The above terms are used only to discriminate one component from the other components. For example, a first component may be referred to as a second component, and similarly, the second component may be referred to as the first component without departing from the scope of the present invention.

Hereinafter, embodiments of the present invention will be described in detail with reference to the accompanying drawings, in which like reference numerals refer to like or similar elements regardless of reference numerals and a duplicated description thereof will be omitted.

Further, in the following description, a detailed explanation of known associated technologies may be omitted to avoid unnecessarily obscuring the subject matter of the present disclosure. Further, it is noted that the accompanying drawings are only for easily understanding the spirit of the present invention and it should not be interpreted that the spirit of the present invention is limited by the accompanying drawings.

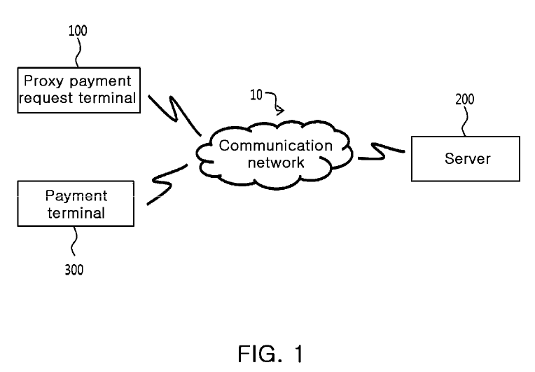

FIG. 1 is a block diagram illustrating a configuration of a system 10 for proxy payment based on a shared electronic commerce shopping cart according to an embodiment of the present invention.

As illustrated In FIG. 1, the system 10 for proxy payment based on the shared electronic commerce shopping cart includes a proxy payment request terminal 100, a server 200, and a payment terminal 300. All the components of the proxy payment system 10 illustrated in FIG. 1 are not required components, and the proxy payment system 10 may be implemented by more components than the components illustrated in FIG. 1 or by less components therethan.

The server 200 provides at least one product information selected by the proxy payment request terminal 100 to the payment terminal 300 designated by the corresponding proxy payment request terminal 100. Thereafter, the server 200 performs a payment function for at least one product corresponding to the at least one product information in which the proxy payment request terminal 100 requests proxy payment by interlocking with the payment terminal 300 and a payment server (not illustrated). Thereafter, the payment terminal 300 and/or the proxy payment request terminal 100 display a payment function execution result provided from the server 200 or the payment server. In this case, the payment cancellation according to the proxy payment may be performed by the payment terminal 300, and the delivery state inquiry for at least one product after payment may be performed by the proxy payment request terminal 100 and/or the payment terminal 300.

The proxy payment request terminal 100 and the payment terminal 300 may be one of various terminals, such as a smart phone, a portable terminal, a mobile terminal, a personal digital assistant (PDA), a portable multimedia player (PMP), a telematics terminal, a navigation terminal, a personal computer, a notebook computer, a slate PC, a tablet PC, an ultrabook, a wearable device (for example, including a smart watch, a smart glass, a head mounted display (HMD), etc.), a Wibro terminal, an Internet protocol television (IPTV) terminal, a smart TV, a digital broadcasting terminal, a television, a 3D television, a home theater system, an audio video navigation (AVN) terminal, an audio/video (A/V) system, a flexible terminal, and the like.

The proxy payment request terminal 100, the server 200, and the payment terminal 300 may be constituted by a communication unit (not illustrated), a storage unit (not illustrated), a display unit (not illustrated), a voice output unit (not illustrated), and a control unit (not illustrated), respectively.

Herein, the communication unit communicates with any internal component or at least any one external terminal via a wired/wireless communication network. In this case, any external terminal may include the proxy payment request terminal 100, the server 200, and the payment terminal 300, and the like. Herein, a wireless Internet technology may include wireless LAN (WLAN), digital living network alliance (DLNA), wireless broadband (Wibro), world interoperability for microwave access (Wimax), high speed downlink packet access (HSDPA), high speed uplink packet access (HSUPA), IEEE 802.16, long term evolution (LTE), long term evolution-advanced (LTE-A), wireless mobile broadband service (WMBS), and the like. The communication unit transmits and receives data according to at least one wireless Internet technology in a range including Internet technologies which are not listed above. Further, a short range communication technology may include Bluetooth, radio frequency identification (RFID), Infrared data association (IrDA), ultra wideband (UWB), ZigBee, near field communication (NFC), ultra sound communication (USC), visible light communication (VLC), Wi-Fi, Wi-Fi Direct, and the like. In addition, a wired communication technology may include power line communication (PLC), USB communication, Ethernet, serial communication, optical/coaxial cables, and the like.

Further, the communication unit may mutually transmit information with any terminal through a universal serial bus (USB).

Further, the communication unit transmits and receives wireless signals with a base station, the proxy payment request terminal 100, the server 200, and the payment terminal 300, and the like on a mobile communication network constructed according to technology standards or communication schemes (for example, GSM (Global System for Mobile communication), CDMA (Code Division Multi Access), CDMA2000 (Code Division Multi Access 2000), EV-DO (Enhanced Voice-Data Optimized or Enhanced Voice-Data Only), WCDMA (Wideband CDMA), HSDPA (High Speed Downlink Packet Access), HSUPA (High Speed Uplink Packet Access), LTE (Long Term Evolution), LTE-A (Long Term Evolution-Advanced), etc.) for mobile communication.

The storage unit stores various user interfaces (UIs) and graphic user interfaces (GUIs).

Further, the storage unit stores data, programs, and the like which are required to operate the proxy payment request terminal 100, the server 200, and the payment terminal 300, and the like.

That is, the storage unit may store a plurality of application programs (alternatively, applications) driven in the proxy payment request terminal 100, the server 200, and the payment terminal 300, and the like, and data and commands for operating the proxy payment request terminal 100, the server 200, and the payment terminal 300, and the like. At least some of the application programs may be downloaded from an external service providing apparatus through wireless communication. Further, at least some of the application programs may be present on the proxy payment request terminal 100, the payment terminal 300, and the like from a release time for basic functions (for example, call receiving and sending functions and message receiving and sending functions) of the proxy payment request terminal 100 and the payment terminal 300. Meanwhile, the application programs are stored in the storage unit and installed in the proxy payment request terminal 100, the server 200, and the payment terminal 300, and the like, and may be driven to perform operations (alternatively, functions) of the proxy payment request terminal 100, the server 200, and the payment terminal 300, and the like by the control unit.

Further, the storage unit may include at least one storage medium of a flash memory type, a hard disk type, a multimedia card micro type, a card type memory (for example, an SD or XD memory, or the like), a magnetic memory, a magnetic disk, an optical disk, a random access memory (RAM), a static random access memory (SRAM), a read-only memory (ROM), an electrically erasable programmable read-only memory (EEPROM), and a programmable read-only memory (PROM). Further, the proxy payment request terminal 100, the server 200, the payment terminal 300, and the like may operate a web storage which performs a storage function of the storage unit on the Internet or also operate in association with the web storage.

Further, the storage units included in the proxy payment request terminal 100 and the payment terminal 300 store (alternatively, install) dedicated applications (for example, shopping applications) by a control of the control unit.

The display unit may display various contents such as various menu screens and the like using a user interface and/or a graphic user interface stored in the storage unit by the control of the control unit. Herein, the contents displayed on the display unit include various text or image data (including various information data), a menu screen including data such as icons, a list menu, and a combo box, and the like. Further, the display unit may be a touch screen.

Further, the display unit may include at least one of a liquid crystal display (LCD), a thin film transistor-liquid crystal display (TFT LCD), an organic light-emitting diode (OLED), a flexible display, a 3D display, an e-ink display, and a light emitting diode (LED).

Further, the display unit may be configured as a stereoscopic display unit displaying a stereoscopic image.

3D display types such as a stereoscopic type (a glasses type), an auto-stereoscopic type (a glassless type), and a projection type (a holographic type) may be applied to the stereoscopic display unit.

Further, the display unit display various information received by the communication unit by the control of the control unit.

The voice output unit outputs voice information included in a predetermined signal processed by the control unit. Herein, the voice output unit may include a receiver, a speaker, a buzzer, and the like.

Further, the voice output unit outputs a guidance voice generated by the control unit.

Further, the voice output unit outputs voice information corresponding to various pieces of information received by the communication unit by the control of the control unit.

The control unit executes overall control functions of the proxy payment request terminal 100, the server 200, and the payment terminal 300.

In addition, the control unit executes overall control functions of the proxy payment request terminal 100, the server 200, and the payment terminal 300 using programs and data stored in the storage unit. The control unit may include a RAM, a ROM, a CPU, a GPU, and a bus, and the RAM, the ROM, the CPU, the GPU, and the like may be connected to each other through the bus. The CPU accesses the storage unit to perform booting by using an O/S stored in the storage unit and perform various operations by using various programs, contents, data, and the like stored in the storage unit.

In addition, the control units included in the proxy payment request terminal 100 and the payment terminal 300 may install (alternatively, register) specific apps (for example, shopping mall apps) in the proxy payment request terminal 100 and the payment terminal 300 by interlocking with the server 200, respectively.

As such, each of the proxy payment request terminal 100, the server 200, and the payment terminal 300 may include a communication unit, a storage unit, a display unit, a voice output unit, a control unit, and the like to perform unique functions of each apparatus.

The proxy payment request terminal 100 (alternatively, a proxy purchase request terminal) communicates with the server 200, the payment terminal 300, and the like.

In addition, the proxy payment request terminal 100 may register a membership to the corresponding server 200 and set a use authority for the shopping cart associated with the proxy payment request terminal 100 at the time of registering the membership.

That is, the proxy payment request terminal 100 may set a write authority for a shopping cart item. In this case, the write authority for the shopping cart item is an authority to perform functions of modification, deletion, newly addition, and the like for one or more pieces of product information which is temporarily stored in the corresponding shopping cart item by other users in addition to the user associated with the corresponding shopping cart item.

Further, the proxy payment request terminal 100 executes a dedicated app (alternatively, an application) installed in the proxy payment request terminal 100 according to a user selection (alternatively, a user touch/input) to display an app execution result screen. Herein, the app execution result screen may be a screen corresponding to a web site (for example, a shopping mall web site) provided from the server 200 associated with the corresponding dedicated app.

In addition, the proxy payment request terminal 100 receives a search word associated with a product to be purchased (alternatively, searched/inquired) by a user (alternatively, a purchaser) associated with the proxy payment request terminal 100 according to a user input.

Further, the proxy payment request terminal 100 transmits the received search word, identification information of the proxy payment request terminal 100, and the like to the server 200. Herein, the identification information of the proxy payment request terminal 100 includes a mobile directory number (MDN), a mobile IP, a mobile MAC, subscriber identity module (Sim) card unique information, a serial number, and the like.

Further, the proxy payment request terminal 100 receives a search result transmitted from the server 200 in response to the received search word, the identification information of the proxy payment request terminal 100, and the like. Herein, the search result includes one or more pieces of product information associated with the product corresponding to the search word. In addition, the product information includes category information of the product, a product name, a product unique code, a product related image, price information, delivery information (for example, including free delivery condition information), seller information, and the like. In addition, the seller information includes a seller name (e.g., a name of the seller, a nickname, an ID, a company name, etc.), location information of the seller, contact information of the seller, a report number of an online marketing business, and the like.

Further, the proxy payment request terminal 100 displays the received search result.

In addition, when there is no product corresponding to a search word among a plurality of products registered in the server 200, the proxy payment request terminal 100 receives information indicating that there is no product corresponding to the search word transmitted from the server 200 in response to the search word, the identification information of the proxy payment request terminal 100, and the like, which are transmitted above.

Further, the proxy payment request terminal 100 displays information indicating that there is no product corresponding to the received search word, and the like.

In addition, the proxy payment request terminal 100 temporarily stores (alternatively, adds) at least one product information (alternatively, at least one product corresponding to at least one product information) selected from one or more pieces of product information provided from the server 200 in the shopping cart item (alternatively, the shopping cart) provided from the corresponding dedicated app (alternatively, the corresponding shopping mall site) in response to the search word associated with the product to be purchased (alternatively, searched/inquired) by the user (alternatively, the purchaser) associated with the proxy payment request terminal 100 according to one or more product information provided from the app execution result screen and/or the user input. In this case, the proxy payment request terminal 100 may be logged in or not logged in to the dedicated app (alternatively, the corresponding shopping mall site).

In addition, when a shopping cart menu displayed on one side of the current screen of the proxy payment request terminal 100 is selected after a process of inquiring the product and storing the product in the shopping cart item according to the user selection, the proxy payment request terminal 100 displays a shopping cart screen (alternatively, a shopping cart screen corresponding to the shopping cart menu) including at least one product information selected above.

In addition, when a delivery information setting menu (alternatively, a delivery information setting item/button) displayed on one side of the shopping cart screen of the proxy payment request terminal 100 is selected, the proxy payment request terminal 100 displays a delivery information setting screen for receiving (alternatively, inputting) delivery information.

In addition, the proxy payment request terminal 100 receives the delivery information according to a user selection (alternatively, a user input). Herein, the delivery information includes a delivery address, a recipient name, a recipient contact number, precaution information on delivery, and the like.

In addition, when a grouping menu (alternatively, a grouping item/button) displayed on the other side of the shopping cart screen of the proxy payment request terminal 100 is selected, the proxy payment request terminal 100 groups at least one product information included in the current shopping cart by interlocking with the server 200 and performs a naming function (alternatively, a group name setting function) for a group (alternatively, a shopping cart group) including at least one product information grouped according to the user input. Further, when a payer selection menu (alternatively, a payer selection item/button) displayed on another side of the shopping cart screen of the proxy payment request terminal 100 is selected, the proxy payment request terminal 100 displays a payer selection screen for selecting the payer to request a proxy payment for at least one product information which is temporarily stored in the current shopping cart item. Herein, the payer selection screen includes one or more telephone numbers stored in the proxy payment request terminal 100, one or more email addresses stored in the proxy payment request terminal 100, one or more pieces of other user information registered as friends (alternatively, followers in Facebook and the like) in a social network account associated with the proxy payment request terminal 100, items for receiving telephone numbers and/or email addresses according to a user input, a plurality of pieces of member information provided from the shopping mall site (alternatively, the server 200) while the proxy payment request terminal 100 accesses, and the like.

Further, the proxy payment request terminal 100 transmits to the server 200 payer information selected by a user selection (alternatively, a user input/touch) from the payer selection screen displayed on the proxy payment request terminal 100, the above received delivery information, proxy payment request information (alternatively, proxy purchase request information) for at least one product information included in the shopping cart item associated with the corresponding proxy payment request terminal 100, the identification information of the proxy payment request terminal 100, and the like. In this case, the payer information includes a telephone number, an email address, social network account information, a member nickname (alternatively, a member ID) within the shopping mall site, and the like. Herein, the identification information of the proxy payment request terminal 100 includes a MDN, a mobile IP, a mobile MAC, subscriber identity module (Sim) card unique information, a serial number, and the like.

Further, when the payer associated with the payer information requesting the proxy payment in the proxy payment request terminal 100 sets a use authority of payment means, coupons, mileages, and the like associated with the corresponding payer to the server 200, the proxy payment request terminal 100 selects (alternatively, applies) usable payment means, coupons, mileages, and the like associated with the corresponding payer by interlocking with the server 200.

Further, the proxy payment request terminal 100 may receive from the server 200 address information about a web page including at least one product information provided to the payment terminal 300 corresponding to the payer information from the server 200.

Further, the proxy payment request terminal 100 manages (alternatively, stores/displays) the address information about the web page including at least one product information provided to the payment terminal 300 corresponding to the payer information provided from the server 200.

Further, when the payment terminal 300 corresponding to the payer information for the proxy payment normally finishes the payment function by interlocking with the server 200 and the payment server (not illustrated), the proxy payment request terminal 100 receives a payment function execution result provided from the payment server (alternatively, directly provided from the corresponding payment server) via the server 200. Herein, the payment function execution result includes a product name for at least one product, a product unique code, a product related image, a payment amount (for example, including an amount of at least one product, a delivery fee, etc.), seller information, and the like.

Further, the proxy payment request terminal 100 displays the received payment function execution result.

Further, the proxy payment request terminal 100 may check a delivery state for the corresponding at least one product in association with at least one product information proxy-paid by the payment terminal 300.

That is, the proxy payment request terminal 100 transmits delivery state check request information about at least one product purchased by the payment terminal 300 before the server 200 and/or a delivery server (not illustrated).

Further, the proxy payment request terminal 100 receives delivery state inquiry information transmitted from the server 200 and/or the delivery server in response to the transmitted delivery state check request information.

Further, the proxy payment request terminal 100 outputs the received delivery state inquiry information.

The server 200 communicates with the proxy payment request terminal 100, the payment terminal 300, and the like.

Further, the server 200 receives the search word transmitted from the proxy payment request terminal 100, the identification information of the proxy payment request terminal 100, and the like.

Further, the server 200 checks (alternatively, searches) a product corresponding to the received search word among a plurality of products registered in the server 200 (alternatively, product information corresponding to the received search word among a plurality of product information associated with a plurality of products). Herein, the plurality of products (alternatively, the plurality of pieces of product information) may be a product (alternatively, product information) registered in the corresponding server 200 in a plurality of sale terminals (not illustrated) (alternatively, a plurality of sellers corresponding to the plurality of sale terminals) registered as sellers in the corresponding server 200. In this case, the product information includes category information of the product, a product name, a product unique code, a product related image, price information, delivery fee information (for example, including free delivery condition information, etc.), seller information, and the like. In addition, the seller information includes a seller name (e.g., including a name of the seller, a nickname, an ID, a company name, etc.), location information of the seller, contact information of the seller, a report number of an online marketing business, and the like.

Further, the server 200 transmits a search result corresponding to the checked (alternatively, searched) search word to the corresponding proxy payment request terminal 100. Herein, the search result includes one or more pieces of product information associated with the product corresponding to the search word, and includes category information of the product, a product name, a product unique code, a product related image, grade information, review information (alternatively, comment information), recommendation information, price information, delivery fee information (for example, including free delivery condition information, etc.), seller information, and the like, according to the search result. In addition, the seller information includes a seller name (e.g., including a name of the seller, a nickname, an ID, a company name, etc.), location information of the seller, contact information of the seller, a report number of an online marketing business, and the like. Further, when there is no product corresponding to the search word among the plurality of products registered in the server 200, the server 200 may transmit information indicating that there is no product corresponding to the search word to the corresponding proxy payment request terminal 100. In addition, the server 200 performs a grouping function for at least one product information included (alternatively, temporarily stored) in a shopping cart (alternatively, a shopping cart item) associated with the corresponding proxy payment request terminal 100 by interlocking with the proxy payment request terminal 100.

In addition, the server 200 performs a naming function (alternatively, a group name setting function) for a group (alternatively, a shopping cart group) including at least one product information grouped by interlocking with the proxy payment request terminal 100.

In addition, the server 200 stores information about a group including at least one grouped product information (for example, including a group name, at least one product information included in the corresponding group, etc.).

At this time, when the proxy payment request terminal 100 is logged in to the dedicated app (alternatively, the shopping mall site), the server 200 stores (alternatively, manages) information on the corresponding group in an account associated with the user of the corresponding proxy payment request terminal 100 by interlocking.

Further, when the proxy payment request terminal 100 is not logged in to the dedicated app (alternatively, the shopping mall site), the server 200 temporarily stores the information on the corresponding group until the proxy payment request terminal 100 ends the access to the corresponding app (alternatively, the shopping mall site), or temporarily stores the identification information of the corresponding proxy payment request terminal 100 and the information on the corresponding group for a predetermined period (for example, 7 days).

As such, when the proxy payment request terminal 100 accesses the server 200 through the dedicated app or the shopping mall site later while the identification information of the corresponding proxy payment request terminal 100 and the information on the corresponding group are temporarily stored in the server 200, the server 200 checks the identification information of the proxy payment request terminal 100 which is currently accessed, and may also provide, to the corresponding proxy payment request terminal 100, information on a temporarily stored group corresponding to the identification information of the corresponding proxy payment request terminal 100 among the temporarily stored information based on the checked identification information of the proxy payment request terminal 100 which is currently accessed.

Further, the server 200 receives payer information transmitted from the proxy payment request terminal 100, delivery information, proxy payment request information (alternatively, proxy purchase request information) about at least one product information included in the shopping cart item associated with the corresponding proxy payment request terminal 100, identification information of the proxy payment request terminal 100, and the like.

Further, the server 200 checks whether the corresponding payer (alternatively, the payer corresponding to the payer information) is a member pre-registered in the server 200 based on the received payer information.

That is, the server 200 checks whether a member nickname and/or a member ID in the shopping mall site is included in the received payer information.

As the checking result, when the payer corresponding to the payer information is not the member pre-registered in the server 200, the server 200 generates a web page capable of checking at least one product information included in the shopping cart item associated with the proxy payment request terminal 100 based on the received proxy payment request information.

That is, as the checking result, when the member nickname and/or the member ID in the shopping mall site is not included in the payer information, the server 200 generates a web page including at least one product information included in the shopping cart item associated with the corresponding proxy payment request terminal 100.

Further, the server 200 transmits (alternatively, provides) address information (alternatively, URL address/web page address information) about the generated web page, proxy payment request information, and the like to the payment terminal 300 corresponding to the received payer information in a text message form, an email form, a social network service form, and the like.

In this case, when the proxy payment request terminal 100 is not logged in to the dedicated app (alternatively, the shopping mall site), the server 200 may also provide (alternatively, transmit) the address information about the corresponding web page even to the proxy payment request terminal 100 so as to check the information when the proxy payment request terminal 100 accesses the corresponding web page later.

Herein, when the shopping cart item including at least one product information to request the proxy payment is named (alternatively, the group name is set), the server 200 may also provide to the payment terminal 300 whether the address for the corresponding web page is used for sharing any purpose of shopping cart by transmitting the group name corresponding to the corresponding shopping cart item together, when transmitting the address information about the web page.

Further, as the checking result, when the payer corresponding to the payer information is a member pre-registered in the server 200, the server 200 determines whether a write authority for the shopping cart item associated with the corresponding payer is set. In this case, the write authority for the shopping cart item is an authority to perform functions of modification, deletion, newly addition, and the like for one or more pieces of product information which is temporarily stored in the corresponding shopping cart item by other users in addition to the user associated with the corresponding shopping cart item.

That is, as the checking result, when the member nickname and/or the member ID in the shopping mall site is included in the payer information, the server 200 determines whether the write authority for the shopping cart item associated with the corresponding payer is set.

As the determining result, when the write authority for the shopping cart item associated with the corresponding payer is not set, the server 200 generates a web page by the above server 200 and transmits address information about the generated web page and the like to the payment terminal 300 (alternatively, another payment terminal) associated with the corresponding payer.

In addition, as the determining result, when the write authority for the shopping cart item associated with the corresponding payer is set, the server 200 checks whether a use authority of payment means, coupons, mileages, and the like associated with the corresponding payer is set.

As the checking result (alternatively, the result of checking whether the use authority is set), when the use authority of payment means, coupons, mileages, and the like associated with the corresponding payer is set, the server 100 selects (alternatively, applies) usable payment means, coupons, mileages, and the like associated with the payer by interlocking with the proxy payment request terminal 100.

Further, as the checking result (alternatively, the result of checking whether the use authority is set), when the use authority of payment means, coupons, mileages, and the like associated with the corresponding payer is not set, or when the payment means, the coupons, the mileages, and the like are selected (alternatively, applied) by interlocking with the above proxy payment request terminal 100, the server 200 copies and pastes and automatically stores (alternatively, temporarily stores) at least one product information included in the shopping cart item associated with the corresponding proxy payment request terminal 100 in the shopping cart item associated with the payment terminal 300 (alternatively, the payment terminal 300 corresponding to the payer information).

In this case, while the shopping cart item including at least one product information to request the proxy payment is named (alternatively, the group name is set) by the proxy payment request terminal 100, when at least one product information included in the web page is copied and pasted to the shopping cart item associated with the corresponding payment terminal 300, the server 200 may store a group name set in the proxy payment request terminal 100 and at least one product information included in the group in the shopping cart item associated with the payment terminal 300 as it is.

That is, while the shopping cart item including at least one product information to request the proxy payment is named (alternatively, the group name is set) by the proxy payment request terminal 100, when at least one product information included in the web page is copied and pasted to the shopping cart item associated with the corresponding payment terminal 300, the server 200 may automatically store (alternatively, copy and paste) a shopping cart set with the group name by the proxy payment request terminal 100 in the shopping cart associated with the payment terminal 300 as it is.

Further, the server 200 generates a web page corresponding to the shopping cart item associated with the payment terminal 300 including at least one product information for the proxy payment.

That is, the server 200 generates a web page capable of checking at least one product information included in the shopping cart item associated with the payment terminal 300 for the proxy payment.

Further, the server 200 transmits, to the payment terminal 300, a web page address (alternatively, a URL address) corresponding to the shopping cart item associated with the generated payment terminal 300, proxy payment request information, and the like in a text message form, an email form, a social network service form, and he like.

In this case, when the proxy payment request terminal 100 is not logged in to the dedicated app (alternatively, the shopping mall site), the server 200 may also provide (alternatively, transmit) the address information about the corresponding web page even to the proxy payment request terminal 100 so as to check the information when the proxy payment request terminal 100 accesses the corresponding web page later.

Herein, when the shopping cart item including at least one product information to request the proxy payment is named (alternatively, the group name is set), the server 200 may also provide to the payment terminal 300 whether the address on the corresponding web page is used for sharing any purpose of shopping cart by transmitting the group name corresponding to the corresponding shopping cart item together, when transmitting the address information about the web page.

Further, by interlocking with the payment terminal 300, the server 200, the payment server, after performing the payment function for at least one product, the server 200 receives a payment function execution result transmitted from the payment server and transmits the received payment function execution result to the corresponding proxy payment request terminal 100 and/or the payment terminal 300.

Further, the server 200 receives delivery state check request information about at least one previously purchased product transmitted from the proxy payment request terminal 100 and/or the payment terminal 300.

Further, the server 200 transmits the previously received delivery state check request information to a delivery server (not illustrated) delivering the corresponding at least one product in order to check the delivery state associated with the corresponding at least one product based on the received delivery state check request information.

Further, the server 200 receives delivery state inquiry information (for example, delivery state inquiry information associated with at least one product) in response to the transmitted delivery state check request information and transmits the received delivery state inquiry information to the proxy payment request terminal 100 and/or the payment terminal 300.

Further, the server 200 may be embodied in a form of a web server, a database server, a proxy server, and the like. Further, in the server 200, a network load distribution mechanism and at least one of a variety of software which allows the server 200 to operate on the Internet or other networks may be installed, and as a result, the server 200 may be embodied by a computerized system. Further, the network may be an http network and may be a private line, the Intranet, or any other networks. Furthermore, the server 300 and the proxy payment request terminal 100/payment terminal 300 may be connected to each other by a security network so as to prevent the data from being attacked by any hacker or other third parties. Further, the server 200 may include a plurality of database servers, and the database servers may be embodied to be separately connected with the server 200 through any type of network connection including a distributed database sever architecture.

The payment terminal 300 (alternatively, a proxy payment terminal/proxy purchase terminal) communicates with the proxy payment request terminal 100, the server 200, and the like.

Further, the payment terminal 300 (alternatively, the payment terminal 300 corresponding to the payer information) receives address information about the web page, a group name, proxy payment request information, and the like, which are transmitted from the server 200.

In addition, the payment terminal 300 displays the address information about the web page, the group name, the proxy payment request information, and the like, which are received. In addition, the payment terminal 300 may register a membership to the corresponding server 200 and set a use authority for the shopping cart associated with the payment terminal 300 at the time of registering the membership.

That is, the payment terminal 300 may seta write authority for a shopping cart item. In this case, the write authority for the shopping cart item is an authority to perform functions of modification, deletion, newly addition, and the like for one or more pieces of product information which is temporarily stored in the corresponding shopping cart item by other users in addition to the user associated with the corresponding shopping cart item.

Also, when the address information about the web page displayed on the payment terminal 300 is selected according to a user selection (alternatively, a user touch) of the payment terminal 300, the payment terminal 300 accesses a web page provided by the corresponding server 200 by interlocking with the server 200.

Further, the payment terminal 300 checks (alternatively, inquires/displays) at least one product information provided from the corresponding web page.

In addition, when the write authority for the shopping cart item associated with the corresponding payer is not set, the payment terminal 300 receives the address information about the web page transmitted from the server 200 and the like and displayed the received address information about the web page and the like.

Further, the payment terminal 300 receives a web page address (alternatively, a URL address) corresponding to the shopping cart item associated with the payment terminal 300 including at least one product information for the proxy payment transmitted from the server 200, a group name, proxy payment request information, and the like.

In addition, the payment terminal 300 displays the address information about the web page, the group name, the proxy payment request information, and the like, which are received.

Also, when the address information about the web page displayed on the payment terminal 300 is selected according to a user selection (alternatively, a user touch) of the payment terminal 300, the payment terminal 300 accesses a web page provided by the corresponding server 200 by interlocking with the server 200.

Further, the payment terminal 300 checks (alternatively, inquires/displays) at least one product information provided from the corresponding web page.

Further, when the payment function for at least one product information included in the shopping cart of the payment terminal 300 is selected, the payment terminal 300 performs a payment function for at least one product associated with at least one selected product information by interlocking with the server 200 and a payment server (not illustrated).

In addition, the payment terminal 300 receive a payment function execution result provided from the payment server (alternatively, directly provided from the corresponding payment server) via the server 200. Herein, the payment function execution result includes a product name for at least one product, a product unique code, a product related image, a payment amount (for example, including an amount of at least one product, a delivery fee, etc.), seller information, and the like.

Further, the payment terminal 300 display the received payment function execution result.

As such, the payment terminal 300 may perform a proxy payment function (alternatively, a proxy purchase function) regardless of a member of the web site associated with the corresponding web page.

In this case, the payment cancellation function for the corresponding paid at least one product may be performed only by the payment terminal 300 performing the corresponding payment function.

Further, the payment terminal 300 may check a delivery state for the corresponding at least one product in association with at least one product information proxy-paid by the payment terminal 300.

That is, the payment terminal 300 transmits delivery state check request information about at least one product purchased by the payment terminal 300 before the server 200 and/or a delivery server (not illustrated).

Further, the payment terminal 300 receives delivery state inquiry information transmitted from the server 200 and/or the delivery server in response to the transmitted delivery state check request information.

Further, the payment terminal 300 outputs the received delivery state inquiry information.

In the embodiment of the present invention, it is described that one payment terminal 300 corresponding to one payer information selected by the proxy payment request terminal 100 performs the proxy payment, but the present invention is not limited thereto, and a plurality of payment terminals 300 selected by the proxy payment request terminal 100 may also perform division payment.

That is, the proxy payment request terminal 100 selects a plurality of pieces of payer information and transmits the selected plurality of pieces of payer information to the server 200. Thereafter, the server 20 may also perform the division payment (alternatively, division proxy payment) for at least one product corresponding to at least one product information selected by the proxy payment request terminal 100 by interlocking with the plurality of payment terminals 300 corresponding to the plurality of pieces of payer information. Further, in the embodiment of the present invention, through the dedicated apps installed in the proxy payment request terminal 100 and/or the payment terminal 300, the configuration that performs various functions described above by communicating with the server 200 is described, but the present invention is not limited thereto. In addition, the proxy payment request terminal 100 and/or the payment terminal 300 may also be configured to access a web site (for example, a shopping mall site) provided by the server 200 and perform the various functions described above through the corresponding accessed web site.

Further, the proxy payment request terminal 100 and/or the payment terminal 300 may further include an interface unit (not illustrated) serving as an interface with all external devices connected to the corresponding proxy payment request terminal 100 and/or the payment terminal 300. For example, the interface unit may be constituted by a wired/wireless headset port, an external charger port, a wired/wireless data port, a memory card port, a port connecting devices with identification modules, an audio input/output (I/O) port, a video input/output (I/O) port, an earphone port, and the like. Herein, the identification module is a chip for storing various types of information for authenticating authority of use of the proxy payment request terminal 100 and/or the payment terminal 300 and may include a user identity module (UIM), a subscriber identity module (SIM), a universal subscriber identity module (USIM), and the like. Further, the device provided with the identification module may be manufactured in a smart card form. Accordingly, the identification module may be connected with the proxy payment request terminal 100 and/or the payment terminal 300 through the port. Such an interface unit receives data or power from an external device to transmit the received data or power to each component in the proxy payment request terminal 100 and/or the payment terminal 300 or transmit the data in the proxy payment request terminal 100 and/or the payment terminal 300 to the external device.

Further, the interface unit may be a passage through which the power is supplied from a cradle to the corresponding proxy payment request terminal 100 and/or the payment terminal 300 when the proxy payment request terminal 100 and/or the payment terminal 300 are connected with an external cradle, or a passage through which various command signals input from the cradle by the user are transmitted to the corresponding proxy payment request terminal 100 and/or the payment terminal 300 by the user. Various command signals input from the cradle or the corresponding power may also operate as a signal for recognizing that the proxy payment request terminal 100 and/or the payment terminal 300 are accurately installed on the cradle.

Further, the proxy payment request terminal 100 and/or the payment terminal 300 may further include an input unit (not illustrated) for receiving a signal according to a button operation or any function selection of the user or receiving a command or a control signal generated by an operation such as touching/scrolling the displayed screen.

The input unit is a means for receiving at least one of a user's command, selection, data, and information and may include a plurality of input keys and function keys for receiving figure or text information and setting various functions.

Further, the input unit may use various devices, such as a key pad, a dome switch, a touch pad (constant pressure type/capacitive type), a touch screen, a jog wheel, a jog switch, a jog shuttle, a mouse, a stylus pen, and a touch pen. Particularly, when the display unit is formed in the touch screen type, some or all of the input functions may be performed by the display unit.

Further, each component (alternatively, each module) of the proxy payment request terminal 100 and/or the payment terminal 300 may be software stored on a memory (alternatively, a storage unit) of the proxy payment request terminal 100 and/or the payment terminal 300. The memory may be an internal memory of the proxy payment request terminal 100 and/or the payment terminal 300 and may an external memory or other types of storage devices. Further, the memory may be a nonvolatile memory. The software stored on the memory may include a command set to allow the proxy payment request terminal 100 and/or the payment terminal 300 to perform a specific operation while executing.

Further, processors mounted on the proxy payment request terminal 100/payment terminal 300 and the server 200 according to the present invention may process program commands for executing the method according to the present invention. In an embodiment, the processor may be a single-threaded processor, and in another embodiment, the processor may be a multi-threaded processor. Further, the processor may process commands stored in the memory or the storage device.

As such, the payment terminal may perform a proxy payment function for one or more products selected by the proxy payment request terminal.

In addition, as such, the purchase request terminal may determine a payment means, whether or not the coupon is applied, whether or not the mileage is used, and the like according to an authority set level set by the payment terminal.

In addition, as such, it is possible to group a plurality of products included in the shopping cart for each purpose according to a purpose, and provide a naming function for the group.

Hereinafter, a method for proxy payment based on a shared electronic commerce shopping cart according to the present invention will be described in detail with reference to FIGS. 1 to 10.

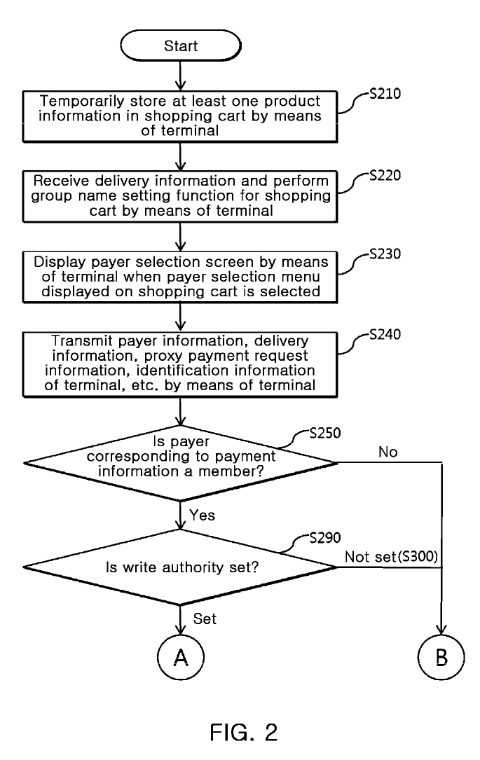

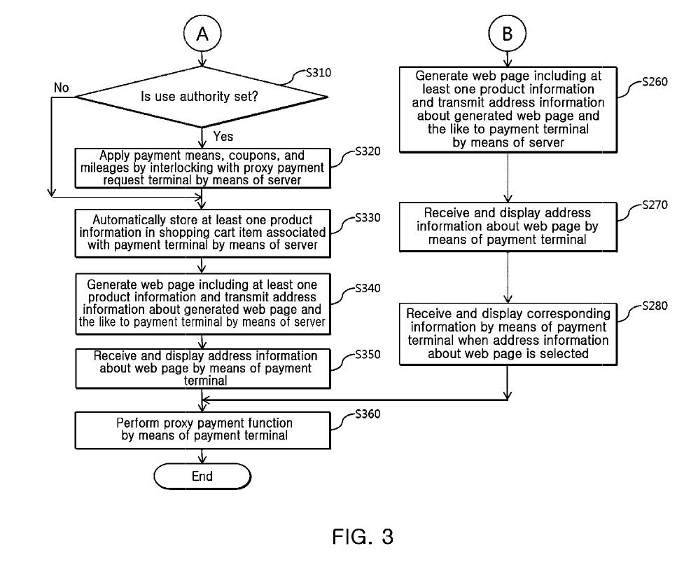

FIGS. 2 and 3 are flowcharts illustrating a method for proxy payment based on a shared electronic commerce shopping cart according to an embodiment of the present invention.

First, the proxy payment request terminal 100 (alternatively, a proxy purchase request terminal) executes a dedicated app (alternatively, an application) installed in the proxy payment request terminal 100 according to a user selection (alternatively, a user touch/input) to display an app execution result screen. Herein, the app execution result screen may be a screen corresponding to a web site (for example, a shopping mall site) provided by the server 200 associated with the corresponding dedicated app.

In addition, the proxy payment request terminal 100 temporarily stores (alternatively, adds) at least one product information (alternatively, at least one product corresponding to at least one product information) selected from one or more pieces of product information provided by the server 200 in the shopping cart item (alternatively, the shopping cart) provided from the corresponding dedicated app (alternatively, the corresponding shopping mall site) in response to the search word associated with the product to be purchased (alternatively, searched/inquired) by the user (alternatively, the purchaser) associated with the proxy payment request terminal 100 according to one or more pieces of product information provided from the app execution result screen and/or the user input. In this case, the proxy payment request terminal 100 may be logged in or not logged in to the dedicated app (alternatively, the corresponding shopping mall site).

In addition, when a shopping cart menu displayed on one side of the current screen of the proxy payment request terminal 100 is selected after a process of inquiring the product and storing the product in the shopping cart item according to the user selection ends, the proxy payment request terminal 100 displays a shopping cart screen (alternatively, a shopping cart screen corresponding to the shopping cart menu) including at least one product information selected above.

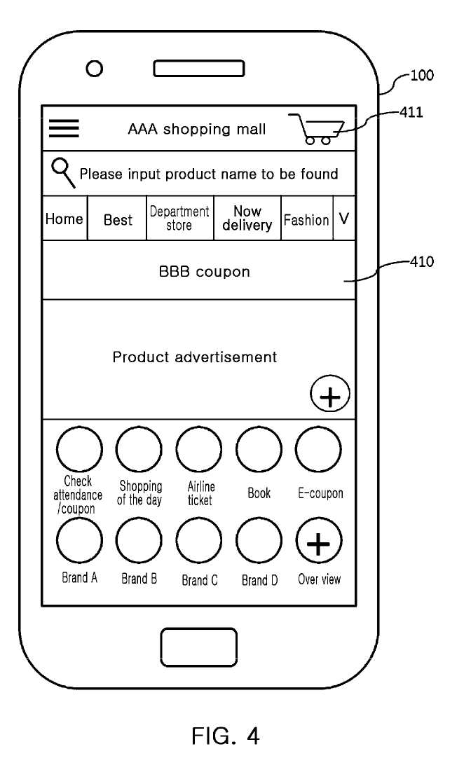

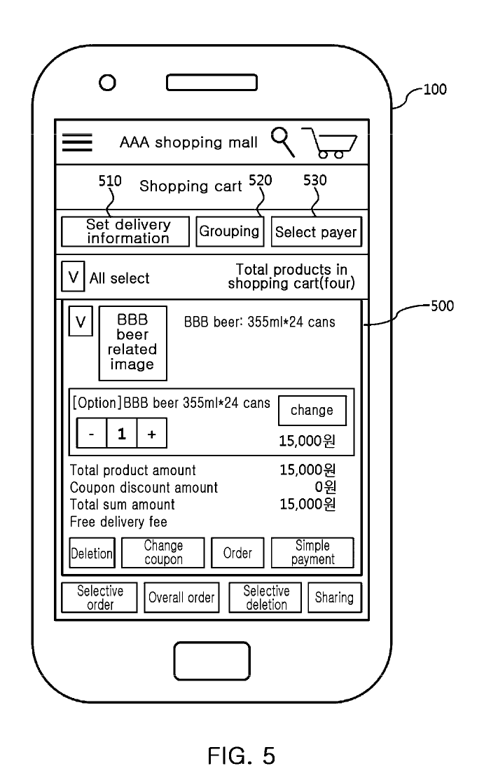

As an example, as illustrated in FIG. 4, when an AAA shopping mall app installed in the proxy payment request terminal 100 is executed, the proxy payment request terminal 100 displays an AAA shopping mall app execution result screen 410. In addition, the proxy payment request terminal 100 adds BBB beer, CCC soju, DDD peanut confectionery, EEE potato chips, and the like inquired by the user of the proxy payment request terminal 100 by interlocking with the server 200 in a shopping cart (alternatively, a shopping cart Item) in a predetermined AAA shopping mall app. In addition, as illustrated in FIG. 4, when a shopping cart menu 411 included in the AAA shopping mall app execution result screen 410 is selected, as illustrated in FIG. 5, the proxy payment request terminal 100 displays a shopping cart screen 500 including product information about BBB beer, CCC soju, DDD peanut confectionery, EEE potato chips, and the like inquired by the user of the proxy payment request terminal 100 stored in the shopping cart (S210).

Thereafter, when a delivery information setting menu (alternatively, a delivery information setting item/button) displayed on one side of the shopping cart screen of the proxy payment request terminal 100 is selected, the proxy payment request terminal 100 displays a delivery information setting screen for receiving (alternatively, being input) delivery information.

In addition, the proxy payment request terminal 100 receives the delivery information according to a user selection (alternatively, a user input). Herein, the delivery information includes a delivery address, a recipient name, a recipient contact number, precaution information on delivery, and the like.

In addition, when a grouping menu (alternatively, a grouping item/button) displayed on the other side of the shopping cart screen of the proxy payment request terminal 100 is selected, the proxy payment request terminal 100 groups at least one product information included in the current shopping cart by interlocking with the server 200 and performs a naming function (alternatively, a group name setting function) for a group (alternatively, a shopping cart group) including at least one product information grouped according to the user input. In addition, the server 200 stores information about a group including at least one grouped product information (for example, a group name, at least one product information included in the corresponding group, etc.).

At this time, when the proxy payment request terminal 100 is logged in to the dedicated app (alternatively, the shopping mall site), the server 200 stores (alternatively, manages) information on the corresponding group in an account associated with the user of the corresponding proxy payment request terminal 100 by interlocking.

Further, when the proxy payment request terminal 100 is not logged in to the dedicated app (alternatively, the shopping mall site), the server 200 temporarily stores the information on the corresponding group until the proxy payment request terminal 100 ends the access to the corresponding app (alternatively, the shopping mall site), or temporarily stores the identification information of the corresponding proxy payment request terminal 100 and the information on the corresponding group for a predetermined period (for example, 7 days).

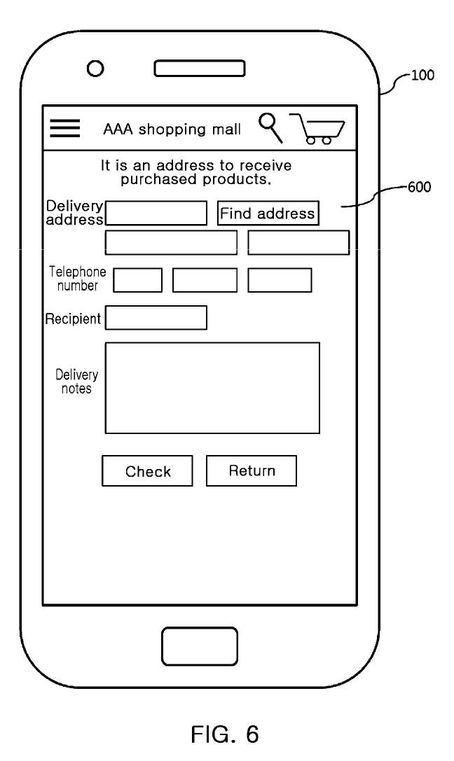

As an example, as illustrated in FIG. 5, when a predetermined delivery information setting menu 510 included in the shopping cart screen 500 is selected, as illustrated in FIG. 6, the proxy payment request terminal 100 displays a delivery information setting screen 600 for receiving delivery information.

In addition, as illustrated in FIG. 6, with respect to a delivery destination item, a telephone number item, a recipient item, a delivery note item, and the like included in the delivery information setting screen 600, the proxy payment request terminal 100 receives first delivery information including a first delivery destination (e.g., 1234-gil, Yeoksam-ro, Gangnam-gu, Seoul), a first telephone number (e.g., 010-1234-5678), a first recipient (e.g., Gil Dong, Hong), a first delivery note (e.g., leave it at the security office), and the like according to a user input.

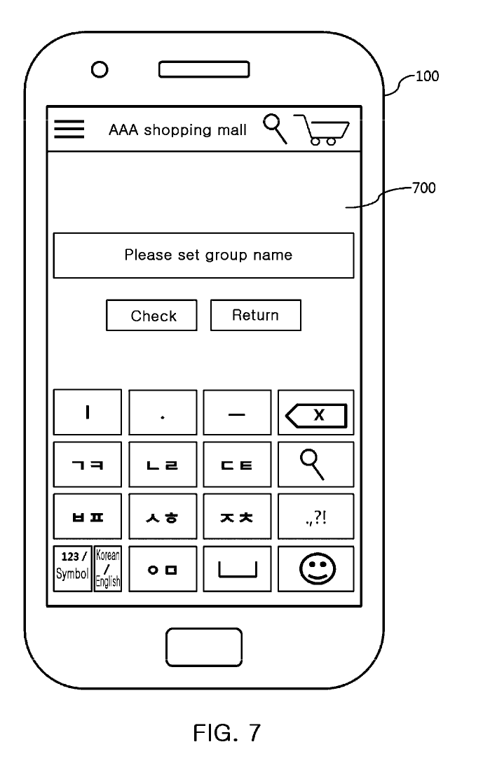

In addition, as illustrated in FIG. 5, when a predetermined grouping menu 520 included in the shopping cart screen 500 is selected, as illustrated in FIG. 7, the proxy payment request terminal 100 groups product information about BBB beer, CCC soju, DDD peanut confectionery, EEE potato chips, and the like included in the current shopping cart item and displays a group name setting screen 700 for setting a group name of the corresponding grouped group.

Further, the proxy payment request terminal 100 sets a first group name (for example, a drink at night) including the product information about BBB beer, CCC soju, DDD peanut confectionery, EEE potato chips, and the like according to the user input (S220).

Further, when a payer selection menu (or a payer selection item/button) displayed on another side of the shopping cart screen of the proxy payment request terminal 100 is selected, the proxy payment request terminal 100 displays a payer selection screen for selecting the payer to request the proxy payment for at least one product information temporarily stored in the current shopping cart item. Herein, the payer selection screen includes one or more telephone numbers stored in the proxy payment request terminal 100, one or more email addresses stored in the proxy payment request terminal 100, one or more pieces of other user information registered as friends (alternatively, followers in Facebook and the like) in a social network account associated with the proxy payment request terminal 100, items for receiving telephone numbers and/or email addresses according to a user input, a plurality of pieces of member information provided by the shopping mall site (alternatively, the server 200) which proxy payment request terminal 100 is accessing, and the like.

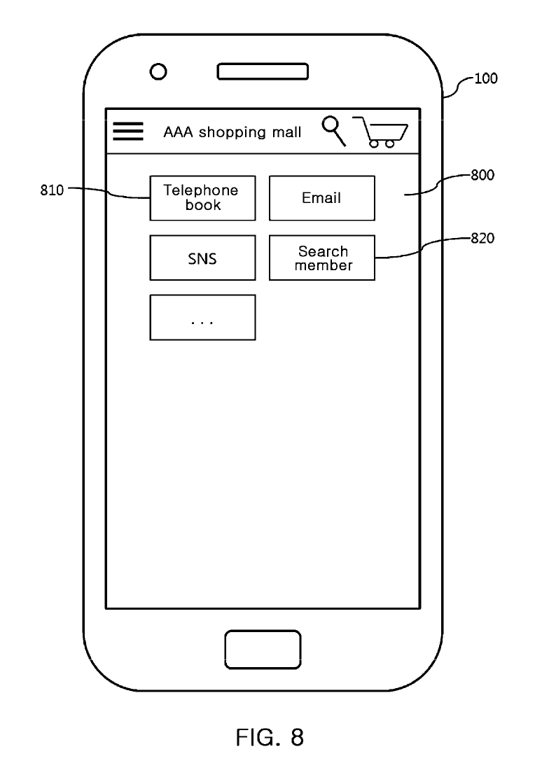

As an example, as illustrated in FIG. 5, when a predetermined payer selection menu 530 included in the shopping cart screen 500 is selected, as illustrated in FIG. 8, the proxy payment request terminal 100 displays a payer selection screen 800 for selecting a payer to request the payment for the product information about BBB beer, CCC soju, DDD peanut confectionery, EEE potato chips, and the like included in the current shopping cart item (S230).

Thereafter, the proxy payment request terminal 100 transmits to the server 200 payer information selected by a user selection (alternatively, a user input/touch) from the payer selection screen displayed on the proxy payment request terminal 100, the above received delivery information, proxy payment request information (alternatively, proxy purchase request information) for at least one product information included in the shopping cart item associated with the corresponding proxy payment request terminal 100, the identification information of the proxy payment request terminal 100, and the like. In this case, the payer information includes a telephone number, an email address, social network account information, a member nickname (alternatively, a member ID) within the shopping mall site, and the like. Herein, the identification information of the proxy payment request terminal 100 includes a MDN, a mobile IP, a mobile MAC, subscriber identity module (Sim) card unique information, a serial number, and the like.

As an example, as illustrated in FIG. 8, when a telephone book menu 810 is selected from the payer selection screen 800 according to the user selection, a prestored telephone book screen (for example, including information (e.g., a name/nickname, a contact number, an abbreviated number, an email address, etc.) about one or more telephone numbers stored in the proxy payment request terminal 100) is displayed on the proxy payment request terminal 100 corresponding to the selected telephone book menu 810, and a wife's telephone number (e.g., 010-1234-9876) which is the family is selected from the displayed telephone book screen, the proxy payment request terminal 100 transmits to the server 200 first payer information (e.g., including wife, telephone number, 010-1234-9876, etc.), first delivery information (for example, including the first delivery destination (e.g., 1234-gil, Yeoksam-ro, Gangnam-gu, Seoul), the first telephone number (e.g., 010-1234-5678), the first recipient (e.g., Gil Dong, Hong), the first delivery note (e.g., leave it at the security office), and the like), first proxy payment request information, identification information of the proxy payment request terminal 100, and the like.

As another example, as illustrated in FIG. 8, when a member searching menu 820 is selected from the payer selection screen 800 according to a user selection, the proxy payment request terminal 100 selects first member information (e.g., the Snow White as a member nickname) registered in the server 200 as second payer information by interlocking with the server 200 in response to the selected member searching menu 820. In addition, the proxy payment request terminal 100 transmits to the server 200 the selected second payer information (e.g., the Snow White as a member nickname registered in the server 200), the first delivery information (for example, including the first delivery destination (e.g., 1234-gil, Yeoksam-ro, Gangnam-gu, Seoul), the first telephone number (e.g., 010-1234-5678), the first recipient (e.g., Gil Dong, Hong), the first delivery note (e.g., leave it at the security office), and the like), second proxy payment request information, identification information of the proxy payment request terminal 100, and the like (S240).

Thereafter, the server 200 receives the payer information transmitted from the proxy payment request terminal 100, the delivery information, the proxy payment request information (alternatively, proxy purchase request information) about at least one product information included in the shopping cart item associated with the corresponding proxy payment request terminal 100, the identification information of the proxy payment request terminal 100, and the like.

Further, the server 200 checks whether the corresponding payer (alternatively, the payer corresponding to the payer information) is a member pre-registered in the server 200 based on the received payer information.

That is, the server 200 checks whether a member nickname and/or a member ID in the shopping mall site are included in the received payer information.

As an example, the server 200 receives the first payer information, the first delivery information, the first proxy payment request information, the identification information of the proxy payment request terminal 100, and the like, which are transmitted from the proxy payment request terminal 100. In addition, the server 200 checks whether the corresponding payer is a member pre-registered in the server 200 based on the received first payer information (e.g., including wife, telephone number, 010-1234-9876, etc.).

That is, the server 200 checks whether a member nickname and/or member ID in the AAA shopping mall site is included in the received first payer information (e.g., including wife, telephone number, 010-1234-9876, etc.).

As another example, the server 200 receives the second payer information, the first delivery information, the second proxy payment request information, the identification information of the proxy payment request terminal 100, and the like, which are transmitted from the proxy payment request terminal 100. In addition, the server 200 checks whether the corresponding payer is a member pre-registered in the server 200 based on the received second payer information (for example, the Snow White which is a member nickname registered in the server 200).

That is, the server 200 checks whether a member nickname and/or member ID in the AAA shopping mall site is included in the received second payer information (for example, the Snow White which is a member nickname registered in the server 200) (S250).

As the checking result, when the payer corresponding to the payer information is not the member pre-registered in the server 200, the server 200 generates a web page capable of checking at least one product information included in the shopping cart item associated with the proxy payment request terminal 100 based on the received proxy payment request information.

That is, as the checking result, when the member nickname and/or the member ID in the shopping mall site is not included in the payer information, the server 200 generates a web page including at least one product information included in the shopping cart item associated with the corresponding proxy payment request terminal 100.

Further, the server 200 transmits (alternatively, provides) address information (alternatively, URL address/web page address information) about the generated web page, proxy payment request information, and the like to the payment terminal 300 corresponding to the received payer information in a text message form, an email form, a social network service form, and the like.

In this case, when the proxy payment request terminal 100 is not logged in to the dedicated app (alternatively, the shopping mall site), the server 200 may also provide (alternatively, transmit) the address information about the corresponding web page even to the proxy payment request terminal 100 so as to check the information when the proxy payment request terminal 100 accesses the corresponding web page later.

Herein, when the shopping cart item including at least one product information to request the proxy payment is named (alternatively, the group name is set), the server 200 may also provide to the payment terminal 300 whether the address on the corresponding web page is used for sharing any purpose of shopping cart by transmitting the group name corresponding to the corresponding shopping cart item together, when transmitting the address information about the web page. As an example, when a payer corresponding to the first payer information (e.g., including wife, telephone number, 010-1234-9876, etc.) is not a member pre-registered in the server 200, that is, when a member nickname and/or member ID in the AAA shopping mall site is not included in the first payer information (e.g., including wife, telephone number, 010-1234-9876, etc.), the server 200 generates a first web page address (e.g., http://www.test.co.kr/shoppingcart0001.html) including product information about BBB beer, CCC soju, DDD peanut confectionery, EEE potato chips, and the like included in the shopping cart item associated with the proxy payment request terminal 100 based on the received first proxy payment request information.

In addition, the server 200 transmits the corresponding generated first web page address (e.g., http://www.test.co.kr/shoppingcart0001.html), the first group name (e.g., a drink at night), the first proxy payment request information, and the like to the first payment terminal 300 corresponding to the received first payer information (e.g., including wife, telephone number, 010-1234-9876, etc.) in a text message form (S260).

Thereafter, the payment terminal 300 (alternatively, the payment terminal 300 corresponding to the payer information) receives address information about the web page transmitted from the server 200, a group name, proxy payment request information, and the like.

In addition, the payment terminal 300 displays the address information about the web page, the group name, the proxy payment request information, and the like, which are received.

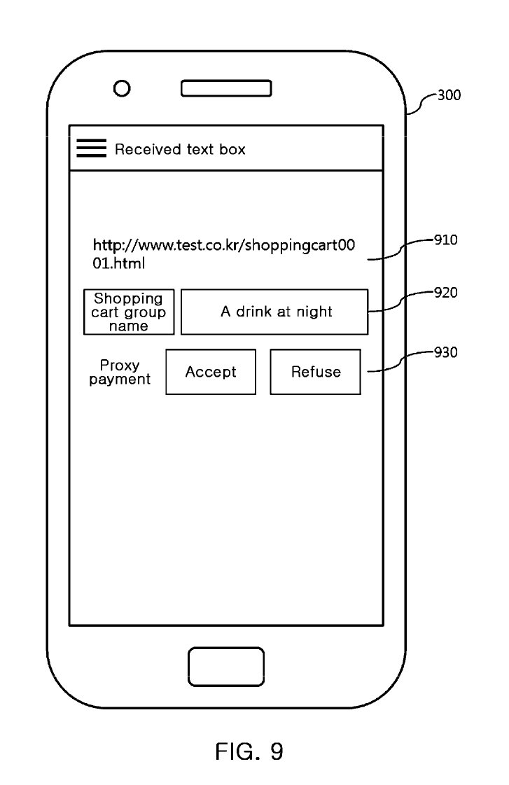

As an example, the first payment terminal corresponding to the wife's telephone (e.g., 010-1234-9876) receives the first web page address (e.g., http://www.test.co.kr/shoppingcart0001.html), the first group name (e.g., a drink at night), the first proxy payment request information, and the like which are transmitted from the server 200, and displays the received first web page address 910 (for example, http://www.test.co.kr/shoppingcart0001.html), the group name 920 (e.g., a drink at night), the first proxy payment request information 930, and the like, as illustrated in FIG. 9. In this case, the first proxy payment request information 930 may include a proxy payment acceptance menu, a proxy payment refusal menu, and the like (S270).

Thereafter, when the address information about the web page displayed on the payment terminal 300 is selected according to a user selection (alternatively, a user touch) of the payment terminal 300, the payment terminal 300 accesses a web page provided by the corresponding server 200 by interlocking with the server 200.

Further, the payment terminal 300 checks (alternatively, inquires/displays) at least one product information provided from the corresponding web page.

As an example, when the first web page address information is selected from the first web page address information 910 (for example, http://www.test.co.kr/shoppingcart0001.html), the group name 920 (for example, a shopping list for this weekend), the first proxy payment request information 930, and the like as illustrated in FIG. 9 by a user touch of the first payment terminal, the first payment terminal accesses the first web page corresponding to the first web page address information by interlocking with the server 200.

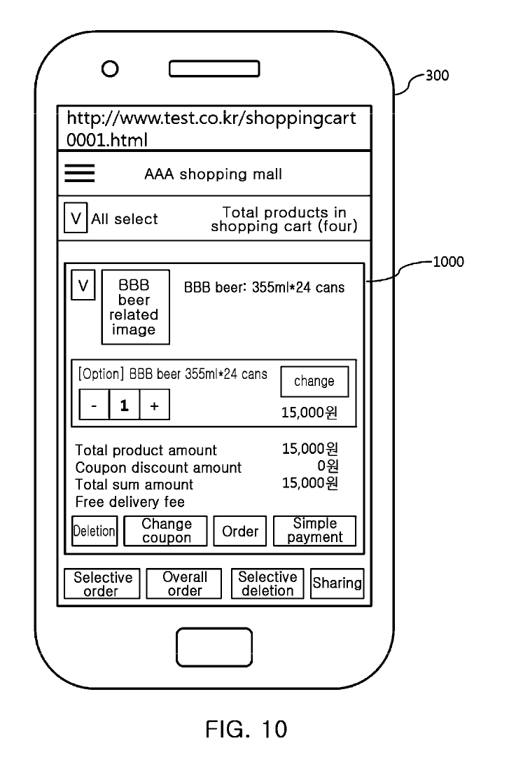

Further, as illustrated in FIG. 10, the first payment terminal displays production information 1000 about BBB beer, CCC soju, DDD peanut confectionery, EEE potato chips, and the like provided from the corresponding first web page (S280). Further, as the checking result, when the payer corresponding to the payer information is a member pre-registered in the server 200, the server 200 determines whether a write authority is set in the shopping cart item associated with the corresponding payer. In this case, the write authority for the shopping cart item is an authority to perform functions of modification, deletion, newly addition, and the like for one or more pieces of product information which is temporarily stored in the corresponding shopping cart item by other users in addition to the user associated with the corresponding shopping cart item.

That is, as the checking result, when the member nickname and/or the member ID in the shopping mall site is included in the payer information, the server 200 determines whether the write authority is set to the shopping cart item associated with the corresponding payer.

As an example, the payer corresponding to the second payer information (for example, the Snow White which is a member nickname registered in the server 200) is a member pre-registered in the server 200, the server 200 determines whether a write authority for the shopping cart item associated with the corresponding payer is set (S290).

As the determining result, when the write authority for the shopping cart item associated with the corresponding payer is not set, the server 200 generates a web page by the server 200 and transmits address information about the generated web page and the like to a payment terminal 300 (alternatively, another payment terminal) associated with the corresponding payer, and the payment terminal 300 receives and displays the address information about the generated web page and the like transmitted from the server 200 and performs previous processes of checking at least one product information provided from the corresponding web page by accessing the corresponding web page by interlocking with the server 200.

As an example, as the determining result, when the write authority for the shopping cart item associated with the corresponding payer is not set, the server 200 generates a second web page address (e.g., http://www.test.co.kr/shoppingcart0002.html) including product information about BBB beer, CCC soju, DDD peanut confectionery, EEE potato chips, and the like included in the shopping cart item associated with the proxy payment request terminal 100 based on the received second proxy payment request information.

Further, the server 200 checks a second payment terminal 300 corresponding to the received second payer information (e.g., the Snow White as the member nickname registered in the server 200) in a plurality of pieces of member information (e.g., terminal numbers for each information/for each nickname) registered in the server 200 and transmits the generated second web page address (e.g., http://www.test.co.kr/shoppingcart0002.html), the first group name (e.g., a drink at night), the second proxy payment request information, and the like to the checked second payment terminal in a text message form.

In addition, the second payment terminal registered as the Snow White which is a nickname in the server 200 receives the second web page address (e.g., http://www.test.co.kr/shoppingcart0002.html), the first group name (e.g., a drink at night), the second proxy payment request information, and the like, which are transmitted from the server 200, and displays the received second web page address (e.g., http://www.test.co.kr/shoppingcart0002.html), the first group name (e.g., a drink at night), the second proxy payment request information, and the like.

Further, when the second web page address information is selected by a user touch of the second payment terminal, the second payment terminal accesses a second web page corresponding to the second web page address information by interlocking with the server 200.

In addition, the second payment terminal displays the product information about BBB beer, CCC soju, DDD peanut confectionery, EEE potato chips, and the like provided from the corresponding second web page (S300).

In addition, as the determining result, when the write authority for the shopping cart item associated with the corresponding payer is set, the server 200 checks whether a use authority of payment means, coupons, mileages, and the like associated with the corresponding payer is set.

As an example, as the determining result, when the write authority for the shopping cart item associated with the corresponding payer is set, the server 200 checks whether a use authority of payment means, coupons, mileages, and the like associated with the corresponding payer is set (S310).

As the checking result (alternatively, the result of checking whether the use authority is set), when the use authority of payment means, coupons, mileages, and the like associated with the corresponding payer is set, the server 100 selects (alternatively, applies) usable payment means, coupons, mileages, and the like associated with the payer by interlocking with the proxy payment request terminal 100.

As an example, as the checking result (alternatively, as the checking result in step S310), when the use authority of the payment means, the coupons, the mileages, and the like associated with the corresponding payer is set, the server 200 selects a first usable coupon associated with the corresponding payer by interlocking with the proxy payment request terminal 100 (S320).

Further, as the checking result (alternatively, the result of checking whether the use authority is set), when the use authority of payment means, coupons, mileages, and the like associated with the corresponding payer is not set, or when the payment means, the coupons, the mileages, and the like are selected (alternatively, applied) by interlocking with the above proxy payment request terminal 100, the server 200 copies and pastes and automatically stores (alternatively, temporarily stores) at least one product information included in the shopping cart item associated with the corresponding proxy payment request terminal 100 in the shopping cart item associated with the payment terminal 300 (alternatively, the payment terminal 300 corresponding to the payer information).

In this case, while the shopping cart item including at least one product information to request the proxy payment is named (alternatively, the group name is set) by the proxy payment request terminal 100, when at least one product information included in the web page is copied and pasted to the shopping cart item associated with the corresponding payment terminal 300, the server 200 may store a group name set in the proxy payment request terminal 100 and at least one product information included in the group in the shopping cart item associated with the payment terminal 300 as it is.

That is, while the shopping cart item including at least one product information to request the proxy payment is named (alternatively, the group name is set) by the proxy payment request terminal 100, when at least one product information included in the web page is copied and pasted to the shopping cart item associated with the corresponding payment terminal 300, the server 200 may automatically store (alternatively, copy and paste) a shopping cart set with the group name by the proxy payment request terminal 100 in the shopping cart associated with the payment terminal 300 as it is.

As an example, when the server 200 selects the usable first coupon associated with the corresponding payer by interlocking with the proxy payment request terminal 100, the server 200 applies the selected first coupon and temporarily stores the product information about BBB beer, CCC soju, DDD peanut confectionery, EEE potato chips, and the like stored in the shopping cart item associated with the proxy payment request terminal 100 in the shopping cart item associated with the second payment terminal.

In this case, the second payment terminal groups the shopping cart item storing the product information about BBB beer, CCC soju, DDD peanut confectionery, EEE potato chips, and the like by interlocking with the server 200 and sets (alternatively, keeps) the corresponding group name as a group name (for example, a drink at night) set in the proxy payment request terminal 100.

As another example, as the checking result (alternatively, as the checking result in step S310), when the use authority of payment means, coupons, mileages, and the like associated with the corresponding payer is not set, the server 200 temporarily stores the product information about BBB beer, CCC soju, DDD peanut confectionery, EEE potato chips, and the like stored in the shopping cart item associated with the corresponding proxy payment request terminal 100 in the shopping cart item associated with the second payment terminal.

In this case, the second payment terminal groups the shopping cart item storing the product information about BBB beer, CCC soju, DDD peanut confectionery, EEE potato chips, and the like by interlocking with the server 200 and sets (alternatively, keeps) the corresponding group name as a group name (for example, a drink at night) set in the proxy payment request terminal 100 (S330).

Thereafter, the server 200 generates a web page corresponding to the shopping cart item associated with the payment terminal 300 including at least one product information for the proxy payment.

That is, the server 200 generates a web page capable of checking at least one product information included in the shopping cart item associated with the payment terminal 300 for the proxy payment.

Further, the server 200 transmits, to the payment terminal 300, a web page address (alternatively, a URL address) corresponding to the shopping cart item associated with the generated payment terminal 300, proxy payment request information, and the like in a text message form, an email form, a social network service form, and he like.

In this case, when the proxy payment request terminal 100 is not logged in to the dedicated app (alternatively, the shopping mall site), the server 200 may also provide (alternatively, transmit) the address information about the corresponding web page even to the proxy payment request terminal 100 so as to check the information when the proxy payment request terminal 100 accesses the corresponding web page later.

Herein, when the shopping cart item including at least one product information to request the proxy payment is named (alternatively, the group name is set), the server 200 may also provide to the payment terminal 300 whether the address on the corresponding web page is used for sharing any purpose of shopping cart by transmitting the group name corresponding to the corresponding shopping cart item together, when transmitting the address information about the web page.

As an example, the server 200 generates a third web page address (e.g., http://www.test.co.kr/shoppingcart0003.html) including the product information about BBB beer, CCC soju, DDD peanut confectionery, EEE potato chips, and the like included in the shopping cart item associated with the second payment terminal.

In addition, the server 200 transmits the corresponding generated third web page address (e.g., http://www.test.co.kr/shoppingcart0003.html), a third group name (e.g., a drink at night), third proxy payment request information, and the like to the second payment terminal corresponding to the second payer information (e.g., the Snow White) in a text message form (S340).

Thereafter, the payment terminal 300 receives a web page address (alternatively, a URL address) corresponding to the shopping cart item associated with the payment terminal 300 including at least one product information for the proxy payment transmitted from the server 200, a group name, proxy payment request information, and the like.

In addition, the payment terminal 300 displays the address information about the web page, the group name, the proxy payment request information, and the like, which are received.

Also, when the address information about the web page displayed on the payment terminal 300 is selected according to a user selection (alternatively, a user touch) of the payment terminal 300, the payment terminal 300 accesses a web page provided by the corresponding server 200 by interlocking with the server 200.

Further, the payment terminal 300 checks (alternatively, inquires/displays) at least one product information provided from the corresponding web page.

As an example, the second payment terminal corresponding to the second payer information (e.g., the Snow White) receives the third web page address (e.g., http://www.test.co.kr/shoppingcart0003.html), the third group name (e.g., a drink at night), the third proxy payment request information, and the like which are transmitted from the server 200, and displays the received third web page address (e.g., http://www.test.co.kr/shoppingcart0003.html), the third group name (e.g., a drink at night), the third proxy payment request information, and the like.

Further, when the third web page address information is selected by a user touch of the second payment terminal, the second payment terminal accesses a third web page corresponding to the third web page address information by interlocking with the server 200. In addition, the second payment terminal displays the product information about BBB beer, CCC soju, DDD peanut confectionery, EEE potato chips, and the like provided from the corresponding third web page (S350).

Thereafter, when the payment function for at least one product information included in the shopping cart of the payment terminal 300 is selected, the payment terminal 300 performs a payment function for at least one product associated with at least one selected product information by interlocking with the server 200 and a payment server (not illustrated).

In addition, the payment terminal 300 and/or the proxy payment request terminal 100 receive a payment function execution result provided from the payment server (alternatively, directly provided from the corresponding payment server) via the server 200. Herein, the payment function execution result includes a product name, a product unique code, a product related image, a payment amount (for example, including an amount of at least one product, a delivery fee, etc.), seller information, and the like for at least one product.

Further, the payment terminal 300 and/or the proxy payment request terminal 100 displays the received payment function execution result.

In this case, the payment cancellation function for the corresponding paid at least one product may be performed only by the payment terminal 300 performing the corresponding payment function.

In addition, the payment terminal 300 and/or the proxy payment request terminal 100 may check a delivery state for the purchased at least one product by interlocking with the server 200 and/or a delivery server (not illustrated).

Further, the payment terminal 300 and/or the proxy payment request terminal 100 may transmit delivery state check request information about at least one product purchased above to the server 200 and/or the delivery server, receive delivery state inquiry information transmitted from the server 200 and/or the delivery server in response to the transmitted delivery state check request information, and output the received delivery state inquiry information.

As an example, when a predetermined payment request item is selected for the proxy payment for the product information about BBB beer, CCC soju, DDD peanut confectionery, EEE potato chips, and the like displayed on the shopping cart screen of the second payment terminal, the second payment terminal performs a payment function by applying the first coupon to the products such as BBB beer, CCC soju, DDD peanut confectionery, EEE potato chips, and the like by interlocking with the server 200 and the payment server and displays the payment function execution result according to the payment function execution provided from the payment server (S360).

The system for proxy payment based on the shared electronic commerce shopping cart according to the embodiment of the present invention can be prepared by computer programs, and codes and code segments configuring the computer programs may be easily deduced by computer programmers in the art. Further, the corresponding computer programs are stored in non-transitory computer readable storage media, and read and executed by a computer or the proxy payment request terminal, the server, the payment terminal, and the like according to the embodiment of the present invention to embody the system for proxy payment based on the shared electronic commerce shopping cart.

The non-transitory computer readable storage media include magnetic recoding media and optical recording media. Computer programs that embody the system for proxy payment based on the shared electronic commerce shopping cart according to the embodiment of the present invention may be stored and installed in embedded memories of the proxy payment request terminal, the server, the payment terminal, and the like. Alternatively, external memories such as smart cards storing and installing the computer programs that embody the proxy payment request terminal, the server, the payment terminal, and the like according to the embodiment of the present invention may also be installed in the proxy payment request terminal, the server, the payment terminal, and the like through an interface.

In the embodiment of the present invention, as described above, the payment terminal performs the proxy payment function for one or more products selected by the proxy payment request terminal to enable proxy payment (alternatively, proxy purchase) without sharing the authentication information associated with the payment terminal with the purchase request terminal, protect personal information of the payer because the authentication information is not shared, and provide a delivery state inquiry function to both the payment terminal and the purchase request terminal.

Further, in the embodiment of the present invention, as described above, the purchase request terminal determines the payment means, whether the coupons are applied, whether the mileages are used, and the like according to an authority setting level set by the payment terminal to enable payers who not familiar with online payment and purchase to easily perform the purchase.

Further, in the embodiment of the present invention, as described above, it is possible to variously and conveniently manage products before purchasing, by grouping a plurality of products in the shopping cart for each purpose according to a purpose and providing a naming function for each group.

Hereinabove, although the present invention is described by specific matters such as concrete components, and the like, embodiments, and drawings, they are provided only for assisting in the entire understanding of the present invention. Therefore, the present invention is not limited to the embodiments. Therefore, the embodiments disclosed in the present disclosure are used to not limit but describe the technical spirit of the present disclosure and the scope of the technical spirit of the present disclosure is not limited by the embodiments. The scope of the present invention should be interpreted by the appended claims and it should be analyzed that all technical spirit in the equivalent range thereto is intended to be embraced by the scope of the present invention.

### INDUSTRIAL AVAILABILITY

According the present invention, the payment terminal performs the proxy payment function for one or more products selected by the proxy payment request terminal to enable proxy payment (alternatively, proxy purchase) without sharing the authentication information associated with the payment terminal with the purchase request terminal, protect personal information of the payer because the authentication information is not shared, and provide a delivery state inquiry function to both the payment terminal and the purchase request terminal. Therefore, the present invention can be widely used for a shopping mall field, a customized service providing field, a shopping cart utilization field, a terminal field, a server field, and the like.

### EXPLANATION OF REFERENCE NUMERALS AND SYMBOLS

10: System for proxy payment
100: Proxy payment request terminal
200: Server
300: Payment terminal

What is claimed is:

1. A method for proxy payment based on a shared electronic commerce shopping cart, the method comprising:
transmitting, by a proxy payment request terminal, payer information, delivery information, proxy payment request information, and identification information of the proxy payment request terminal to a server in order to request proxy payment for at least one product information stored in a shopping cart associated with the proxy payment request terminal;
transmitting, by the server, a web page address including the at least one product information and the proxy payment request information to a payment terminal corresponding to the payer information according to whether the payer corresponding to the payer information is registered as a member in the server;
displaying, by the payment terminal, the web page address transmitted from the server and the proxy payment request information; and
performing, by the payment terminal, a payment function for at least one product associated with the at least one product information included in the shopping cart of the payment terminal by interlocking with the server and a payment server, when the payment function for the at least one product information included in the shopping cart of the payment terminal is selected.

2. The method of claim 1, wherein the transmitting of the payer information, the delivery information, the proxy payment request information, and the identification information of the proxy payment request terminal includes:
a process of storing, by the proxy payment request terminal, the at least one product information for requesting proxy payment in the shopping cart associated with the proxy payment request terminal by interlocking with the server;
a process of displaying, by the proxy payment request terminal, a shopping cart screen including the at least one product information when a shopping cart menu displayed on one side of the current screen of the proxy payment request terminal is selected;
a process of displaying, by the proxy payment request terminal, a delivery information setting screen when a delivery information setting menu displayed on one side of the shopping cart screen is selected, and receiving delivery information according to a user input;
a process of grouping, by the proxy payment request terminal, the at least one product information included in a current shopping cart of the proxy payment request terminal by interlocking with the server when a grouping menu displayed on the other side of the shopping cart screen is selected;
a process of performing, by the proxy payment request terminal, a group name setting function for a group including the at least one grouped product information according to a user input;
a process of displaying, by the proxy payment request terminal, a payer selection screen for selecting a payer to request the proxy payment for at least one product information temporarily stored in a current shopping cart item when a payer selection menu displayed on another side of the shopping cart screen is selected, and receiving payer information according to a user input; and
a process of transmitting, by the proxy payment request terminal, the received payer information, the received delivery information, the set group name, the proxy payment request information, and the identification information of the proxy payment request terminal to the server.

3. The method of claim 2, wherein the payer information includes any one of a telephone number, an email address, social network account information, and a member nickname in a shopping mall site associated with the server.

4. The method of claim 1, wherein the transmitting of the web page address including the at least one product information and the proxy payment request information to the payment terminal corresponding to the payer information according to whether the payer corresponding to the payer information is registered as the member in the server includes
a process of checking, by the server, whether the payer corresponding to the payer information is a member pre-registered in the server;
a process of determining whether a write authority for the shopping cart item associated with the payer is set, when the payer corresponding to the payer information is the member pre-registered in the server, as the checking result;
a process of checking whether a use authority for at least one of payment means, coupons, and mileages associated with the payer is set, when the write authority for the shopping cart item associated with the payer is set, as the determining result;
a process of applying at least one of usable payment means, coupons, and mileages associated with the payer by interlocking with the server and the proxy payment request terminal, when the use authority for at least one of the payment means, the coupons, and the mileages associated with the payer is set;
a process of copying and pasting and automatically storing at least one product information included in the shopping cart item associated with the proxy payment request terminal in the shopping cart item associated with the payment terminal, in the case of either when the use authority for at least one of the payment means, the coupons, and the mileages associated with the payer is not set or when at least one of the usable payment means, coupons, and mileages associated with the payer is applied by interlocking with the proxy payment request terminal;
a process of generating a web page corresponding to the shopping cart item associated with the payment terminal; and
a process of providing address information about the generated web page and the proxy payment request information to the payment terminal corresponding to the received payer information.

5. The method of claim 4, wherein as the checking result, when the payer corresponding to the payer information is not the member pre-registered in the server, the method includes
a process of generating a web page capable of checking at least one product information included in the shopping cart item associated with the proxy payment request terminal based on the received proxy payment request information; and
a process of providing address information about the generated web page and the proxy payment request information to the payment terminal corresponding to the received payer information.

6. The method of claim 4, wherein as the determining result, when the write authority for the shopping cart item associated with the payer is not set, the method includes
a process of generating a web page capable of checking at least one product information included in the shopping cart item associated with the proxy payment request terminal based on the received proxy payment request information; and
a process of providing address information about the generated web page and the proxy payment request information to the payment terminal corresponding to the received payer information.

7. The method of claim 1, further comprising:
transmitting, by any one of the proxy payment request terminal and the payment terminal, delivery state check request information about the at least one product paid to the server;
receiving, by any one of the proxy payment request terminal and the payment terminal, delivery state inquiry information transmitted from the server in response to the transmitted delivery state check request information; and
outputting, by any one of the proxy payment request terminal and the payment terminal, the received delivery state inquiry information.

8. A non-transitory computer readable storage medium storing a computer program comprising a set of instructions, when executed, arranged to cause a terminal to implement a method for proxy payment based on a shared electronic commerce shopping cart, the method comprising:
transmitting, by a proxy payment request terminal, payer information, delivery information, proxy payment request information, and identification information of the proxy payment request terminal to a server in order to request proxy payment for at least one product information stored in a shopping cart associated with the proxy payment request terminal;
transmitting, by the server, a web page address including the at least one product information and the proxy payment request information to a payment terminal corresponding to the payer information according to whether the payer corresponding to the payer information is registered as a member in the server;
displaying, by the payment terminal, the web page address transmitted from the server and the proxy payment request information; and
performing, by the payment terminal, a payment function for at least one product associated with the at least one product information included in the shopping cart of the payment terminal by interlocking with the server and a payment server, when the payment function for the at least one product information included in the shopping cart of the payment terminal is selected.

9. A system for proxy payment based on a shared electronic commerce shopping cart, the system comprising:
a proxy payment request terminal configured to transmit payer information, delivery information, proxy payment request information, and identification information of the proxy payment request terminal to a server in order to request proxy payment for at least one product information stored in a shopping cart associated with the proxy payment request terminal;
the server configured to transmit a web page address including the at least one product information and the proxy payment request information to a payment terminal corresponding to the payer information according to whether the payer corresponding to the payer information is registered as a member in the server; and
the payment terminal configured to display the web page address transmitted from the server and the proxy payment request information, and perform a payment function for at least one product associated with the at least one product information included in the shopping cart of the payment terminal by interlocking with the server and a payment server when the payment function for the at least one product information included in the shopping cart of the payment terminal is selected.

10. The system of claim 9, wherein the server is configured to
check whether the payer corresponding to the payer information is a member pre-registered in the server,
determine whether a write authority for a shopping cart item associated with the payer is set when the payer corresponding to the payer information is the member pre-registered in the server,
check whether a use authority for at least one of payment means, coupons, and mileages associated with the payer is set when the write authority for the shopping cart item associated with the payer is set,
apply at least one of usable payment means, coupons, and mileages associated with the payer by interlocking with the server and the proxy payment request terminal when the use authority for at least one of the payment means, the coupons, and the mileages associated with the payer is set,
copy and paste and automatically store at least one product information included in the shopping cart item associated with the proxy payment request terminal in the shopping cart item associated with the payment terminal, in the case of either when the use authority for at least one of the payment means, the coupons, and the mileages associated with the payer is not set or when at least one of the usable payment means, coupons, and mileages associated with the payer is applied by interlocking with the proxy payment request terminal,
generate a web page corresponding to the shopping cart item associated with the payment terminal, and
provides address information about the generated web page and the proxy payment request information to the payment terminal corresponding to the received payer information.

11. The system of claim 9, wherein any one of the proxy payment request terminal and the payment terminal is configured to transmit delivery state check request information about the at least one product paid to the server, receive delivery state inquiry information transmitted from the server in response to the transmitted delivery state check request information, and output the received delivery state inquiry information.
